(19) United States
(12) Patent Application Publication
(10) Pub. No.: US 2006/0061805 A1
(43) Pub. Date: Mar. 23, 2006

(54) Information processing apparatus and print control method for the information processing apparatus

(75) Inventor: Kenichi Kawamura, Niigata (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/052,235

(22) Filed: Feb. 8, 2005

(30) Foreign Application Priority Data
Sep. 22, 2004 (JP) 2004-275807

(51) Int. Cl. G06F 3/12

(52) U.S. Cl. 358/1.15

(57) ABSTRACT

An image processing apparatus for causing a printer to print a screen supplied by a Web server and viewed by a Web browser, comprises print data preparing unit that prepares print data in a plurality of patterns different in sheet size and sheet orientation from data of the screen supplied by the Web server and viewed by the Web browser; preview data preparing unit that prepares preview data corresponding to the plurality of print data prepared by the print data preparing unit; display control unit that displays previews corresponding to the plurality of patterns based on the preview data prepared by the preview data preparing unit; selecting unit that selects a preview suitable for the print from the previews which correspond to the plurality of patterns and are displayed by the display control unit; and print data transmitting unit that transmits print data corresponding to the preview selected by the selecting unit to the printer.

### TECHNOLOGICAL FIELD

The present invention relates to an information processing apparatus and a control method for the information processing apparatus, which cause a printer to print screens supplied by Web servers and viewed by a Web browser. More particularly, the present invention relates to an information processing apparatus and a control method for the information processing apparatus, which enable a user to easily print screens, which are supplied by Web servers and viewed by a Web browser, in a state desired by the user.

### BACKGROUND ART

When screens supplied by Web servers are printed by a conventional general-purpose Web browser used for browsing the Web servers, the printed screens may differ from the display state of the original screens. For example, in the printed screens, the right side may be missing, or the screen may not be covered in one page, but extend to the next page.

In such a case, a user has to repeat changing of print setting and print operations until an expected print result is achieved. Consequently, it usually takes a long time to print the screens supplied by the Web servers.

There have been proposed apparatuses which use a preview screen for the print processing as disclosed in the JP 2003-177906A and JP 2003-177904A.

The apparatus disclosed in JP 2003-177906A enables a user to view a preview screen so as to determine the orientation for sheets to be set on a printer.

Also, the apparatus disclosed in JP 2003-177904A enables a user to carry out desired operations during the previewing processing.

However, in JP 2003-177906A, a user first sees the preview screen and then sets the sheets on the printer. Therefore, the printing cannot start immediately. Further, in JP 2003-177904A, a user changes setting such as magnification adjustment during the preparation of preview data, and therefore it is necessary to change the setting many times until an expected result is achieved.

### SUMMARY OF THE INVENTION

The present invention has been made in view of the above circumstances and provide an information processing apparatus and a print control method for the information processing apparatus which enable a user to easily print screens that are supplied by Web servers and viewed by a Web browser, in a state desired by the user.

According to an aspect of the present invention, an image processing apparatus for causing a printer to print a screen supplied by a Web server and viewed by a Web browser, comprises print data preparing unit that prepares print data in a plurality of patterns different in sheet size and sheet orientation from data of the screen supplied by the Web server and viewed by the Web browser; preview data preparing unit that prepares preview data corresponding to the plurality of print data prepared by the print data preparing unit; display control unit that displays previews corresponding to the plurality of patterns based on the preview data prepared by the preview data preparing unit; selecting unit that selects a preview suitable for the print from the previews which correspond to the plurality of patterns and are displayed by the display control unit; and print data transmitting unit that transmits print data corresponding to the preview selected by the selecting unit to the printer.

The information processing apparatus and the print control method for the information processing apparatus according to the present invention are applicable to cases where screens supplied by Web servers and viewed by a Web browser are to be printed on a printer. According to the present invention, the user only needs to select a preview from plural previews so as to easily and promptly print the screens supplied by Web servers and are viewed by a Web browser, in a state desired by the user.

### BRIEF DESCRIPTION OF THE DRAWINGS

Preferred embodiment of the present invention will be described in detail based on the following figures, wherein:

FIG. 1 is a block diagram schematically illustrating the configuration of an embodiment of an information processing apparatus according to the present invention;

FIG. 2 shows examples of a plurality of combination patterns of sheet size and orientation previously set to a printer driver shown in FIG. 1;

FIG. 3 is a flowchart illustrating print processing for a Web server screen in the information processing apparatus shown in FIG. 1;

FIG. 4 is an example of a screen for the print of a Web server screen used in the information processing apparatus shown in FIG. 1; and

FIG. 5 is an example of a printing pattern setting screen for Web server screen printing used in the information processing apparatus shown in FIG. 1.

### DESCRIPTION OF THE EMBODIMENTS

A detailed description will now be given of an embodiment of an information processing apparatus and a print control method for the information processing apparatus according to the present invention with reference to accompanying drawings.

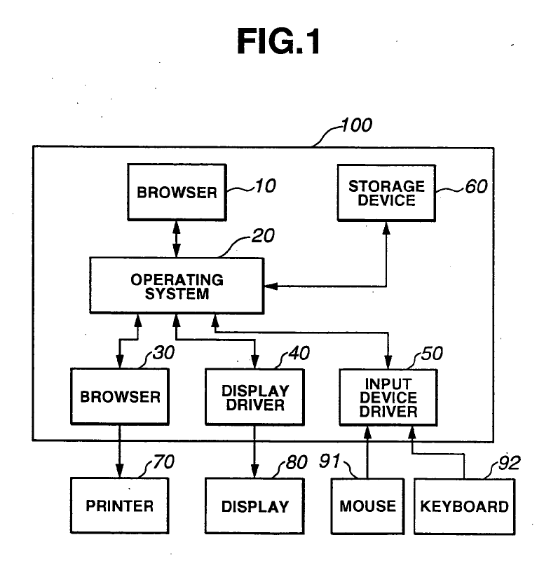

FIG. 1 is a block diagram schematically illustrating the configuration of an embodiment of an information processing apparatus according to the present invention.

Referring to FIG. 1, an information processing apparatus 100 comprises a browser 10, an operating system 20, a printer driver 30, a display driver 40, an input device driver 50, and a storage device 60.

A printer 70 is connected to the printer driver 30, a display unit 80 is connected to the display driver 40, and a mouse 91 and a keyboard 92 are connected to the input device driver 50.

The browser 10 has a function of accessing the Internet and the like to view screens supplied by Web servers on the Internet.

The operating system 20 supervises and controls various processing of the information processing apparatus 100.

The printer driver 30 prepares print data used for the printing by the printer 70, and also prepares preview data corresponding to the print data.

The display driver 40 controls display processing on the display unit 80, and the input device driver 50 carries out input control of the input devices such as the mouse 91 and the keyboard 92.

The storage device 60 stores the print data and the preview data prepared by the printer driver 30.

In order to enable a user to easily and promptly carry out the print in a desired state in which the right side of a print result is not missing and a print result properly fits in one page and thus does not extend to the next page upon printing the web server screens viewed on the browser 10, the information processing apparatus 100 is configured as follows. A plurality of combination patterns of sheet size and orientation are prepared in the printer driver 30 in advance; the printer driver 30 prepares print data and preview data based on the plurality of combination patterns of sheet size and orientation; and the preview data prepared by the printer driver 30 are displayed on the display unit 80. When the user selects a preview suitable for the print, the print data corresponding to the selected preview is scaled up or down to the size of sheets set on the printer, and is transmitted to the printer 70. The print is carried out by using the transmitted print data.

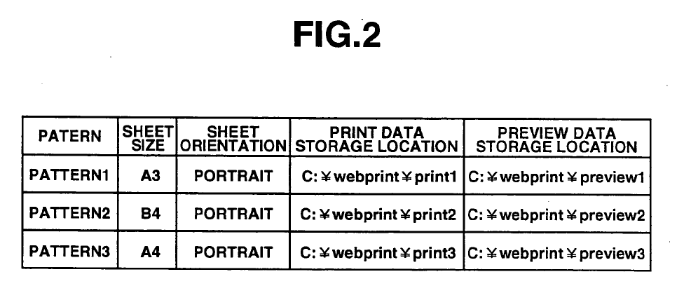

FIG. 2 shows examples of the plurality of combination patterns of sheet size and orientation set in advance to the printer driver 30.

FIG. 2 shows a case where patterns 1 to 3 are set as the combination patterns of the sheet size and orientation. In this case, the sheet size and the sheet orientation are “A3” and “Portrait” in the pattern 1, “B4” and “Portrait” in the pattern 2 and “A4” and “Portrait” in the pattern 3.

Corresponding to these patterns 1 to 3, path information is set such as “C:¥webprint¥print1” indicating the storage location in the storage device 60 for the print data prepared according to the patterns 1 to 3.

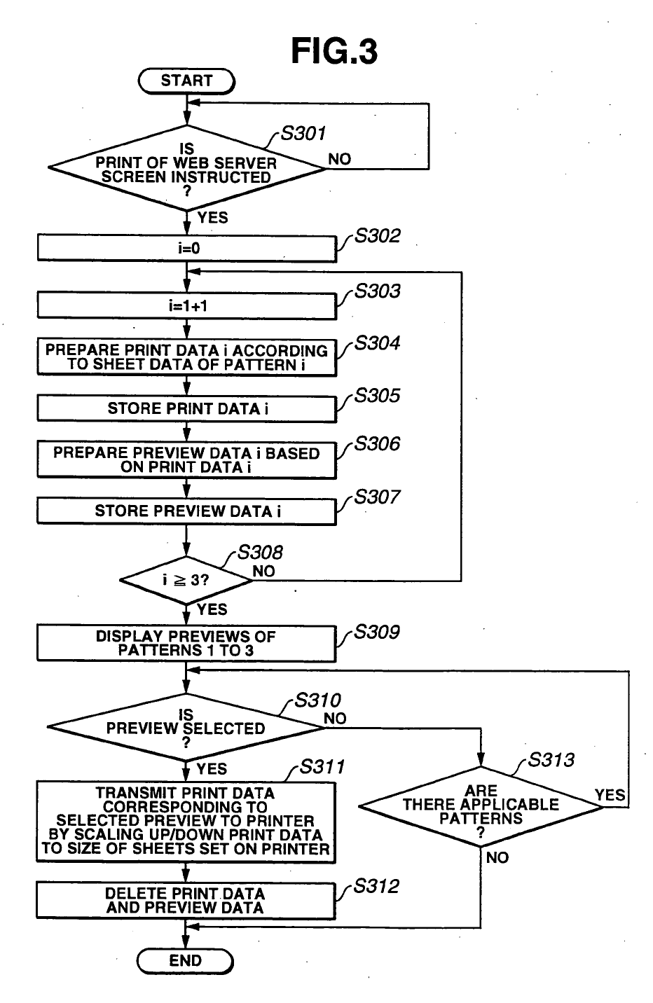

FIG. 3 is a flowchart illustrating processing for printing a screen of a Web server on the information processing apparatus 100.

Referring to FIG. 3, when the print of a screen supplied by a Web server is instructed while this Web server screen is being viewed on the display unit 80 with a browser 10 (“YES” in step 301), the printer driver 30 acquires data of the screen supplied by the Web server from the browser 10 via the operating system 20, and prepares print data and preview data corresponding to the plurality of patterns (three patterns, the pattern 1 to 3, shown in FIG. 2 in the present embodiment) based on the data of the screen supplied by the Web server.

Specifically, a pattern number “I” first set to “0” (step 302), the pattern number “i” is then incremented by “1” (step 303), the data of the screen supplied by the Web server is acquired from the browser 10 via the operating system 20, and print data i is prepared according to the sheet data of the pattern i (the sheet size and orientation of the pattern i shown in FIG. 2) based on the data of the screen supplied by the Web server (step 304).

The prepared print data i is stored onto the storage device 60 according to the print data storage location for the pattern i shown in FIG. 2 (step 305).

Preview data i is then prepared based on the print data i of the pattern i (step 306), and the preview data i is stored onto the storage device 60 according to the preview data storage location for the pattern i shown in FIG. 2 (step S307).

It is then determined whether the pattern number “i” has reached “3” (step 308). If the pattern number “i” has not reached “3” (“NO” in the step 308), the print processing returns to the step 303, and repeats the processing from the step 303 to 307 until the pattern number “i” reaches “3”.

In the above manner, all the print data 1 to 3 and the preview data 1 to 3 corresponding to the patterns 1 to 3 are stored onto the storage device 60, and when it is determined that the pattern number “i” has reached “3” in the step 308 (“YES” in the step 308), the previews corresponding to the patterns 1 to 3 are shown on the display unit 80 based on the preview data 1 to 3, which correspond to the patterns 1 to 3, and are stored on the storage device 60 (step 309).

Specifically, the display driver 40 shown in FIG. 1 acquires the preview data 1 to 3 corresponding to the patterns 1 to 3 from the storage device 60 via the operating system 20 based on the preview data storage locations set by the printer driver 70 and shown in FIG. 2. Based on the acquired preview data corresponding to the patterns 1 to 3, a screen showing the printing of the Web server screen including the previews corresponding to the patterns 1 to 3 is displayed on the display unit 80.

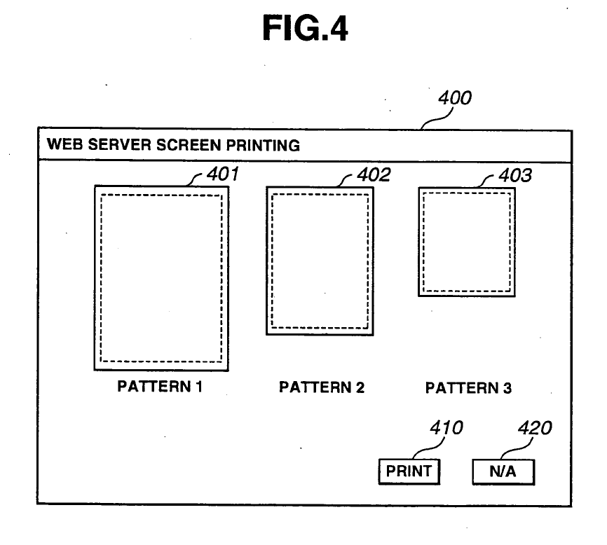

FIG. 4 is an example of the screen showing the printing of the Web server screen displayed on the display unit 80.

Referring to FIG. 4, the screen 400 showing the printing of the Web server screen displays a “Print” button 410 and an “N/A (no applicable pattern)” button 420 used to input instructions by the user together with the previews 401, 402, 403 that correspond to the patterns 1 to 3, respectively.

On the screen 400, the preview 401 corresponding to the pattern 1 is the preview by the print data for the Web server screen prepared with the sheet size “A3” and orientation “Portrait” shown in FIG. 2 and, the preview 402 corresponding to the pattern 2 is the preview by the print data for the Web server screen with the sheet size “B4” and orientation “Portrait” shown in FIG. 2, and the preview 403 corresponding to the pattern 3 is the preview by the print data for the Web server screen prepared with the sheet size “A4” and orientation “Portrait” shown in FIG. 2.

The user checks the previews 401, 402, 403, from which the user selects an appropriate preview which does not have defects such as a missing right side and an unnecessary extension to the next page due to misfit by using the mouse 91.

When the user selected the appropriate preview and clicked the print button 410 by using the mouse 91, the print processing starts using the print data corresponding to the selected preview.

Note that if all the previews 401, 402, 403 corresponding to the patterns 1 to 3 have defects such as a missing right side or an unnecessary extension to the next page due to misfit into one page on the screen for Web server screen printing 400 shown in FIG. 4, the user uses the mouse 91 to click the N/A button 420. In this case, since an expected print result cannot be achieved by using the print data corresponding to the patterns 1 to 3, the user finishes the print processing. If the user wishes to perform the printing processing, it is necessary to newly set the patterns 1 to 3.

Specifically, if any of the previews 401, 402, 403 corresponding to the patterns 1 to 3 is selected, and the print button 410 is clicked on the screen for Web server screen printing 400 shown in FIG. 4, it is determined that a preview is selected in step 310 in FIG. 3 (“YES” in step 310), and the print data corresponding to the selected preview is scaled up or down to the size of the sheets set on the printer 70, and is transmitted to the printer 70 (step 311).

When, for example, the preview 401 of the pattern 1 is selected, the print button 410 is clicked on the screen for Web server screen printing 400. Supposing that the size of the sheets set on the printer 70 in FIG. 1 is “A4”, the printer driver 30 in FIG. 1 acquires the print data 1 corresponding to the pattern 1 in the “A3” size from the storage device 60 via the operating system 20 based on the print data storage location shown in FIG. 2, scales down the print data 1 in the “A3” size to the “A4” size of the sheets, and transmits the print data 1 to the printer 70.

Consequently, the print starts on the printer 70 based on the print data 1. It has been confirmed that the print data 1 of the pattern 1 does not have defects such as a missing right side and an unnecessary extension to the next page due to misfit into one page on the screen 400 for the print of the Web server screen shown in FIG. 4, and the print data 1 of the pattern 1 is scaled up or down to the size of the sheets set on the printer 70, and is transmitted to the printer 70. It is therefore possible to cause the printer 70 to output an expected print result which does not have the defects.

When the processing in the step 311 ends, the print data 1 to 3 and preview data 1 to 3 corresponding to the patterns 1 to 3 prepared for the print processing of the Web server screen becomes unnecessary. Therefore, these data are deleted from the storage device 60 (step 312), and the print processing of the Web server screen ends.

When it is determined that a preview is not selected in the step 310 in FIG. 3 (“NO” in the step 310), it is then determined whether there is no applicable pattern, namely the N/A button 420 has been clicked on the screen for Web server screen printing 400 shown in FIG. 4 (step 313). If the N/A button 420 has been clicked and it is determined that there is no applicable pattern (“NO” in the step 313), the processing ends. To perform the printing processing, it is necessary to newly set the patterns 1 to 3.

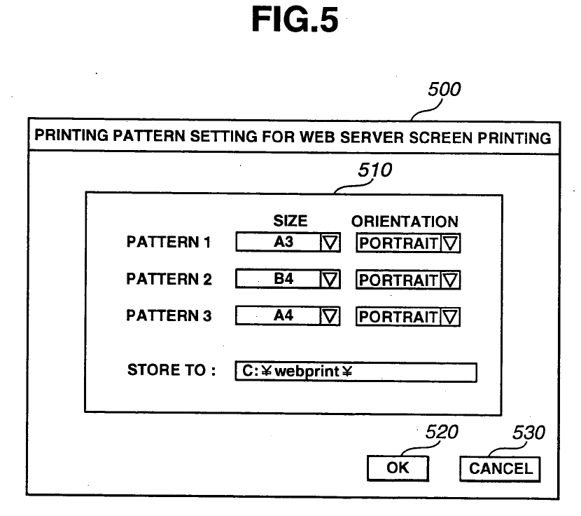

FIG. 5 is an example of a printing pattern setting screen for Web server screen printing for setting the patterns 1 to 3.

On the printing pattern setting screen for Web server screen printing 500 shown in FIG. 5, a setting section 510 for setting the patterns 1 to 3, an OK button 520 for making the setting in the setting section 510 effective, and a cancel button 530 for canceling the setting are provided.

In the setting section 510 for the patterns 1 to 3, a sheet size setting section 511 and a sheet orientation setting section 512 respectively used to change and set the sheet size and orientation for the patterns 1 to 3, and an input section 513 for inputting these settings into a storage location are provided.

On the printing pattern setting screen for Web server screen printing 500, if the sheet size for the pattern 1 is to be changed, for example, the sheet size for the pattern 1 can be changed by operating a button 511a of the sheet size setting section 511 to select other sheet size, and clicking the OK button using the mouse 91.

As describe above, even if there is no applicable pattern on the screen for Web server screen printing 400 shown in FIG. 4, a user can perform a desired printing by using the printing pattern setting screen for Web server screen printing 500. Specifically, by using the printing pattern setting screen for Web server screen printing 500, the size and orientation of the respective patterns are changed, the OK button is then clicked so as to change the settings of the patterns 1 to 3, and the print of the Web server screen is instructed so as to carry out the print processing shows in FIG. 3 while the screen supplied by the Web server is viewed by the browser 10 on the display unit 80.

In the above embodiment, the number of the patterns to be set is three, i.e., the pattern 1 to 3. However, the number of the patterns is not limited to three, and may be any number.

Further, the above embodiment is so configured that, when the print of the Web server screen is instructed while the screen supplied by the Web server is viewed on the display unit 80 by means of the browser 10, the print processing shown in FIG. 3 is carried out, and the screen for the Web server screen printing 400 shown in FIG. 4 is displayed. However, the present invention is not limited by the above configuration. Alternatively, there may be provided such a configuration that whether the print processing in FIG. 3 is carried out or not is selected and instructed on an ordinary print screen.

If the print of the Web server screen extends to several pages, there may be provided such a configuration that the preview is switched to show for the respective pages on the screen for Web server screen printing 400 shown in FIG. 4. In this case, there may be provided such a configuration that the print instruction is given for the each page.

Furthermore, in the above embodiment, the present invention is applied to the case in which the screen of a Web server viewed by a Web browser is to be printed. However, the present invention is not limited to the above embodiment. The present invention is also applicable to a case where the screen displayed on a display unit is to be printed.

What is claimed is:

1. An image processing apparatus for causing a printer to print a screen supplied by a Web server and viewed by a Web browser, comprising:
print data preparing unit that prepares print data in a plurality of patterns different in sheet size and sheet orientation from data of the screen supplied by the Web server and viewed by the Web browser;
preview data preparing unit that prepares preview data corresponding to the plurality of print data prepared by the print data preparing unit;
display control unit that displays previews corresponding to the plurality of patterns based on the preview data prepared by the preview data preparing unit;
selecting unit that selects a preview suitable for the print from the previews which correspond to the plurality of patterns and are displayed by the display control unit; and
print data transmitting unit that transmits print data corresponding to the preview selected by the selecting unit to the printer.

2. The information processing apparatus according to claim 1, further comprising:
managing unit that stores and manages the plurality of print data prepared by the print data preparing unit and the plurality of preview data prepared by the preview data preparing unit; and
deleting unit that deletes the print data stored and managed by the managing unit after the print data transmitting unit has completed the transmission of the print data to the printer.

3. The information processing apparatus according to claim 1, further comprising:
pattern setting unit with which a user sets the plurality of patterns to be used when the print data preparing unit preparing the print data,
wherein if no suitable preview exists among the previews which correspond to the plurality of patterns and are displayed by the display control unit, another plurality of patterns are set by the pattern setting unit so as to enable the display control unit to display another previews.

4. A print control method for an image processing apparatus that causes a printer to print a screen supplied by a Web server and viewed by a Web browser, comprising:
causing a print data preparing unit to prepare print data in a plurality of patterns different in sheet size and sheet orientation from data of the screen supplied by the Web server and viewed by the Web browser;
causing a display control unit to display previews corresponding to the plurality of patterns based on the preview data prepared by the preview data preparing unit;
causing a selecting unit to select a preview suitable for the print from the previews which correspond to the plurality of patterns and are displayed by the display control unit; and
causing a print data transmitting unit to transmit print data corresponding to the preview selected by the selecting unit to the printer.

5. An image processing apparatus for causing a printer to print a screen displayed on a display unit, comprising:
print data preparing unit that prepares print data in a plurality of patterns different in sheet size and sheet orientation from data of the screen displayed on the display unit;
preview data preparing unit that prepares preview data corresponding to the plurality of print data prepared by the print data preparing unit;
display control unit that displays previews corresponding to the plurality of patterns based on the preview data prepared by the preview data preparing unit;
selecting unit that selects a preview suitable for the print from the previews which correspond to the plurality of patterns and are displayed by the display control unit; and
print data transmitting unit that transmits print data corresponding to the preview selected by the selecting unit to the printer.
